(19) United States
(12) Patent Application Publication
(10) Pub. No.: US 2007/0005530 A1
(43) Pub. Date: Jan. 4, 2007

(54) Selecting grid executors via a neural network

(75) Inventors: Randall Paul Baartman, Rochester, MN (US); Steven Joseph Branda, Rochester, MN (US); Surya V. Duggirala, Eagan, MN (US); John Joseph Stecher, Rochester, MN (US); Robert Wisniewski, Rochester, MN (US)

Correspondence Address: IBM CORPORATION;ROCHESTER IP LAW DEPT. 917, 3605 HIGHWAY 52 NORTH, ROCHESTER, MN, 55901-7829, US

(73) Assignee: INTERNATIONAL BUSINESS MACHINES CORPORATION, ARMONK, NY (US)

(21) Appl. No.: 11/138,938

(22) Filed: May 26, 2005

(51) Int. Cl. G06F 15/18

(52) U.S. Cl. 706/16

(57) ABSTRACT

A method, apparatus, system, and signal-bearing medium that, in an embodiment, send units of work to grid executors, create training data based on the performance of the grid executors, and train a neural network via the training data. The training data includes pairs of input and output data, where the input data is the types of the units of work and the output data is the service strengths of the grid executors. Once the neural network has been trained, subsequent units of work have their grid executors selected by inputting the types of the units of work to the neural network and receiving a service strength from the neural network as output. The grid executors are then selected based on the output service strength from the neural network. In this way, in an embodiment, the grid performance may be increased.

### FIELD

This invention generally relates to grid computer systems and more specifically relates to selecting a grid executor via a neural network.

### BACKGROUND

The development of the EDVAC computer system of 1948 is often cited as the beginning of the computer era. Since that time, computer systems have evolved into extremely sophisticated devices, and computer systems may be found in many different settings. Computer systems typically include a combination of hardware, such as semiconductors and circuit boards, and software, also known as computer programs.

Years ago, computer systems were stand-alone devices that did not communicate with each other. But today, computers are increasingly connected via networks, such as the Internet. When connected via a network, one computer, often called a client, may request services from another computer, often called a server. Further, a computer that acts as a client in one scenario may act as a server in another scenario. In addition to the Internet example above, companies often have internal networks that connect their various computers together. A large company with hundreds of thousands of employees may have hundreds of thousands of computers all connected via a network. Many of these computers are idle for much of the time. For example, typical office workers have computers on their desks, which they use for a few hours each day to check e-mail, compose an occasional document, or request services from a server computer. The rest of the day, the office worker spends on the telephone, in meetings, or at home while the computer sits unused and idle. Thus, many companies have hundreds of millions of dollars invested in computers that are underutilized.

These companies would naturally like to find a way to use this vast, underutilized, but widely distributed, computer capacity. One technique for using idle computer capacity is called grid computing. In grid computing, a grid controller breaks up a task at one computer into multiple, smaller units of work (UOW). The grid controller sends each unit of work to multiple receiving computers in parallel via a network for execution. Some of these receiving computers execute the unit of work and send the results back quickly. Other of the receiving computers execute the unit of work and send the results back more slowly. Still others never receive the unit of work, receive the unit of work but never execute it, or execute unit of work but never send the results back. The grid controller uses the first results that are returned for a particular unit of work and ignores the other, later results. In addition to the benefit of saving money by using underutilized computer resources, grid computing also has the advantage of performance benefits, by breaking up a large task into many smaller units of work and executing them in parallel.

In order to increase the performance benefits, some grid controllers keep track of the availability of computers in the network, and issue the units of work that have the highest priority to the computers in the network with the highest availability. Similarly, the grid controllers issue the units of work with lower priorities to the computers in the network that have less availability. While the technique of keeping track of computer availability does boost performance, there is a need for more advanced techniques that increase grid performance even more.

### SUMMARY

A method, apparatus, system, and signal-bearing medium are provided that, in an embodiment, send units of work to grid executors, create training data based on the performance of the grid executors, and train a neural network via the training data. The training data includes pairs of input and output data, where the input data is the types of the units of work and the output data is the service strengths of the grid executors. Once the neural network has been trained, subsequent units of work have their grid executors selected by inputting the types of the units of work to the neural network and receiving a service strength from the neural network as output. The grid executors are then selected based on the output service strength from the neural network. In this way, in an embodiment, the grid performance may be increased.

### BRIEF DESCRIPTION OF THE DRAWINGS

Various embodiments of the present invention are hereinafter described in conjunction with the appended drawings:

FIG. 1 depicts a high-level block diagram of an example system for implementing an embodiment of the invention.

FIG. 2 depicts a block diagram of selected components of the example system, according to an embodiment of the invention.

FIG. 3 depicts a flowchart of processing for registering a grid executor, according to an embodiment of the invention.

FIG. 4 depicts a flowchart for processing units of work in a training mode, according to an embodiment of the invention.

FIG. 5 depicts a flowchart for processing units of work in a performance mode, according to an embodiment of the invention.

It is to be noted, however, that the appended drawings illustrate only example embodiments of the invention, and are therefore not considered limiting of its scope, for the invention may admit to other equally effective embodiments.

### DETAILED DESCRIPTION

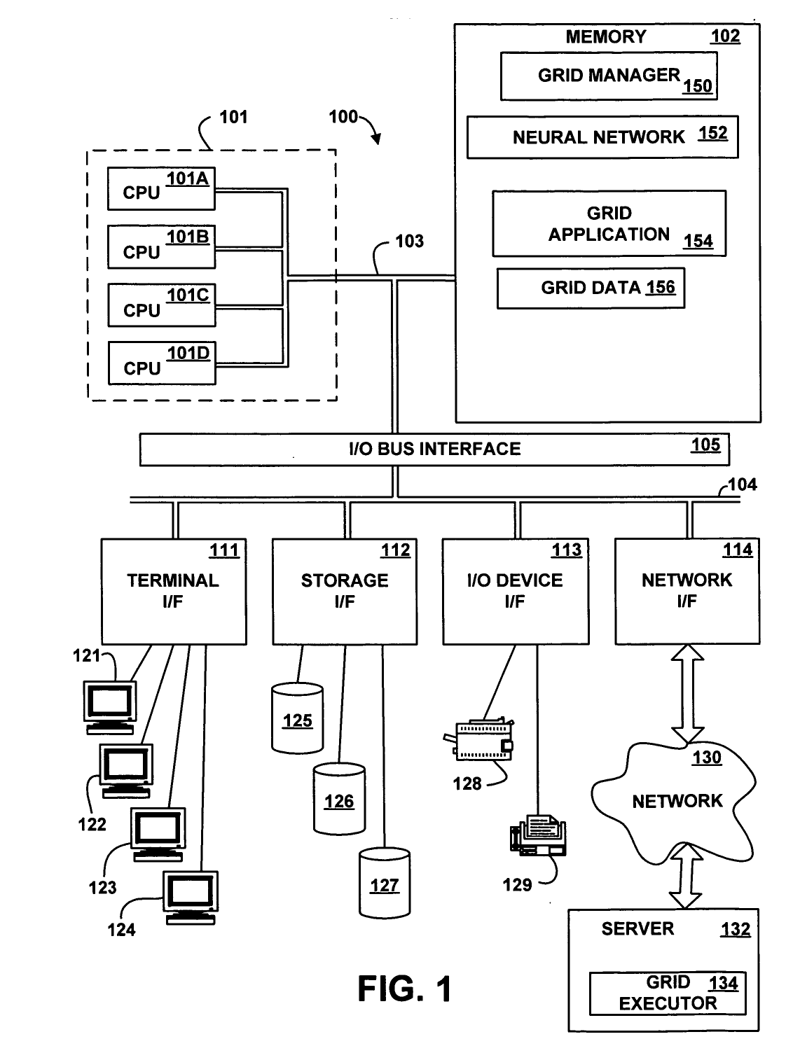

Referring to the Drawings, wherein like numbers denote like parts throughout the several views, FIG. 1 depicts a high-level block diagram representation of a computer system 100 connected via a network 130 to a server 132, according to an embodiment of the present invention. In an embodiment, the hardware components of the computer system 100 may be implemented by an eServer iSeries computer system available from International Business Machines of Armonk, N.Y. However, those skilled in the art will appreciate that the mechanisms and apparatus of embodiments of the present invention apply equally to any appropriate computing system. The computer system 100 acts as a client for the server 132, but the terms “server” and “client” are used for convenience only, and in other embodiments an electronic device that is used as a server in one scenario may be used as a client in another scenario, and vice versa.

The major components of the computer system 100 include one or more processors 101, a main memory 102, a terminal interface 111, a storage interface 112, an I/O (Input/Output) device interface 113, and communications/network interfaces 114, all of which are coupled for inter-component communication via a memory bus 103, an I/O bus 104, and an I/O bus interface unit 105.

The computer system 100 contains one or more general-purpose programmable central processing units (CPUs) 101A, 101B, 101C, and 101D, herein generically referred to as the processor 101. In an embodiment, the computer system 100 contains multiple processors typical of a relatively large system; however, in another embodiment the computer system 100 may alternatively be a single CPU system. Each processor 101 executes instructions stored in the main memory 102 and may include one or more levels of on-board cache.

The main memory 102 is a random-access semiconductor memory for storing data and programs. In another embodiment, the main memory 102 represents the entire virtual memory of the computer system 100, and may also include the virtual memory of other computer systems coupled to the computer system 100 or connected via the network 130. The main memory 102 is conceptually a single monolithic entity, but in other embodiments the main memory 102 is a more complex arrangement, such as a hierarchy of caches and other memory devices. For example, the main memory 102 may exist in multiple levels of caches, and these caches may be further divided by function, so that one cache holds instructions while another holds non-instruction data, which is used by the processor or processors. The main memory 102 may be further distributed and associated with different CPUs or sets of CPUs, as is known in any of various so-called non-uniform memory access (NUMA) computer architectures.

The main memory 102 includes a grid manager 150, a neural network 152, a grid application 154, and grid data 156. Although the grid manager 150, the neural network 152, the grid application 154, and the grid data 156 are illustrated as being contained within the memory 102 in the computer system 100, in other embodiments some or all of them may be on different computer systems and may be accessed remotely, e.g., via the network 130. The computer system 100 may use virtual addressing mechanisms that allow the programs of the computer system 100 to behave as if they only have access to a large, single storage entity instead of access to multiple, smaller storage entities. Thus, while the grid manager 150, the neural network 152, the grid application 154, and the grid data 156 are illustrated as being contained within the main memory 102, these elements are not necessarily all completely contained in the same storage device at the same time. Further, although the grid manager 150, the neural network 152, the grid application 154, and the grid data 156 are illustrated as being separate entities, in other embodiments some of them, or portions of some of them, may be packaged together.

The grid manager 150 breaks up tasks generated by the grid application 154 into multiple units of work and sends the units of work to the servers 132 for execution. In various embodiments, the grid application 154 may be a user application, a third party application, an operating system, any portion thereof, or any other appropriate executable or interpretable code or statements. The grid manager 150 uses the grid data 156 and the neural network 152 to choose the appropriate servers 132 to receive the units of work.

The neural network 152 is a parallel computing model analogous to the human brain, consisting of multiple simple processing units (processors or code) connected by adaptive weights. In various embodiments, the neural network 152 may be either supervised or unsupervised. A supervised neural network differs from conventional programs in that a programmer does not write algorithmic code to tell the neural network how to process data. Instead, the neural network is trained by presenting training data of the desired input/output relationships to the neural network. An unsupervised neural network can extract statistically significant features from input data. This differs from supervised neural networks in that only input data is presented to the neural network during training. The neural network 152 has a learning mechanism, which operates by updating the adaptive weights after each training iteration. Once a sufficient level of training has been achieved by the neural network 152, for example, the neural network 152 produces the desired input/output relationships specified by the training data, the training of the neural network 152 ceases, and the neural network 152 no longer updates its adaptive weights. Instead, the neural network 152 enters a performance mode, during which the neural network 152 receives input data and produces output data using the trained adaptive weights.

Many different types of computing models exist that fall under the label “neural networks.” These different models have unique network topologies and learning mechanisms. Examples of known neural network models are the Back Propagation Model, the Adaptive Resonance Theory Model, the Self-Organizing Feature Maps Model, the Self-Organizing TSP Networks Model, and the Bidirectional Associative Memories Model, but in other embodiments any appropriate model may be used.

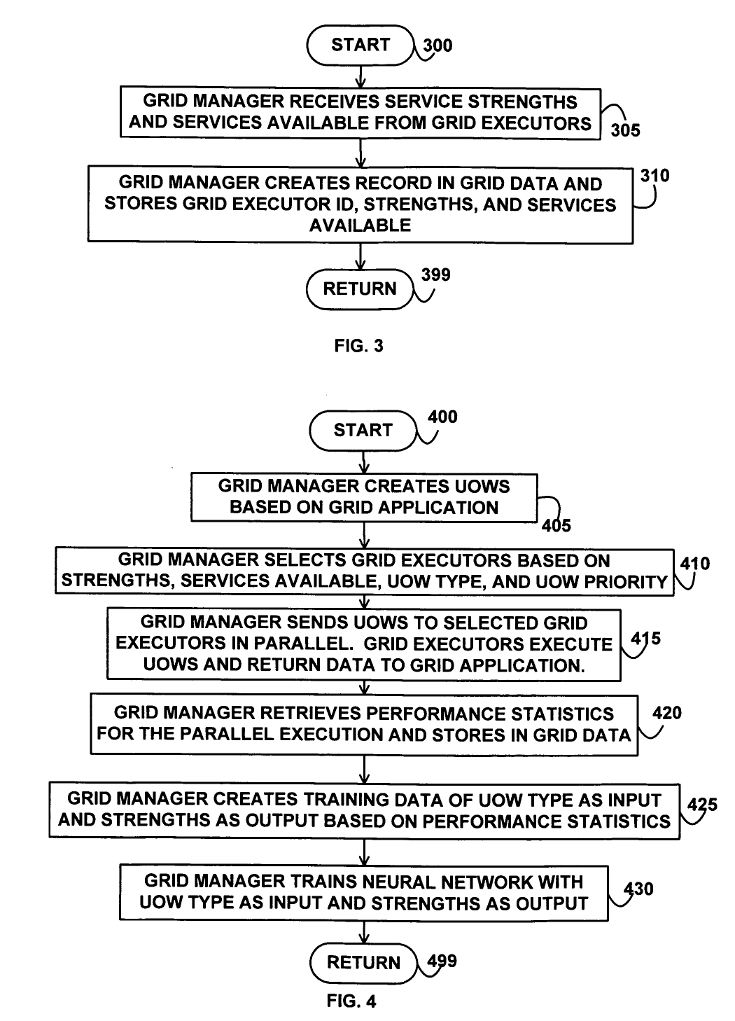

In an embodiment, the grid manager 150 includes instructions capable of executing on the processor 101 or statements capable of being interpreted by instructions executing on the processor 101 to perform the functions as further described below with reference to FIGS. 3, 4, and 5. In another embodiment, the grid manager 150 may be implemented in microcode. In another embodiment, the grid manager 150 may be implemented in hardware via logic gates and/or other appropriate hardware techniques in lieu of or in addition to a processor-based system.

The memory bus 103 provides a data communication path for transferring data among the processor 101, the main memory 102, and the I/O bus interface unit 105. The I/O bus interface unit 105 is further coupled to the system I/O bus 104 for transferring data to and from the various I/O units. The I/O bus interface unit 105 communicates with multiple I/O interface units 111, 112, 113, and 114, which are also known as I/O processors (IOPs) or I/O adapters (IOAs), through the system I/O bus 104. The system I/O bus 104 may be, e.g., an industry standard PCI bus, or any other appropriate bus technology.

The I/O interface units support communication with a variety of storage and I/O devices. For example, the terminal interface unit 111 supports the attachment of one or more user terminals 121, 122, 123, and 124. The storage interface unit 112 supports the attachment of one or more direct access storage devices (DASD) 125, 126, and 127 (which are typically rotating magnetic disk drive storage devices, although they could alternatively be other devices, including arrays of disk drives configured to appear as a single large storage device to a host). The contents of the main memory 102 may be stored to and retrieved from the direct access storage devices 125, 126, and 127, as needed.

The I/O and other device interface 113 provides an interface to any of various other input/output devices or devices of other types. Two such devices, the printer 128 and the fax machine 129, are shown in the exemplary embodiment of FIG. 1, but in other embodiment many other such devices may exist, which may be of differing types. The network interface 114 provides one or more communications paths from the computer system 100 to other digital devices and computer systems; such paths may include, e.g., one or more networks 130.

Although the memory bus 103 is shown in FIG. 1 as a relatively simple, single bus structure providing a direct communication path among the processors 101, the main memory 102, and the I/O bus interface 105, in fact the memory bus 103 may comprise multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 105 and the I/O bus 104 are shown as single respective units, the computer system 100 may in fact contain multiple I/O bus interface units 105 and/or multiple I/O buses 104. While multiple I/O interface units are shown, which separate the system I/O bus 104 from various communications paths running to the various I/O devices, in other embodiments some or all of the I/O devices are connected directly to one or more system I/O buses.

The computer system 100 depicted in FIG. 1 has multiple attached terminals 121, 122, 123, and 124, such as might be typical of a multi-user “mainframe” computer system. Typically, in such a case the actual number of attached devices is greater than those shown in FIG. 1, although the present invention is not limited to systems of any particular size. The computer system 100 may alternatively be a single-user system, typically containing only a single user display and keyboard input, or might be a server or similar device which has little or no direct user interface, but receives requests from other computer systems (clients). In other embodiments, the computer system 100 may be implemented as a personal computer, portable computer, laptop or notebook computer, PDA (Personal Digital Assistant), tablet computer, pocket computer, telephone, pager, automobile, teleconferencing system, appliance, or any other appropriate type of electronic device.

The network 130 may be any suitable network or combination of networks and may support any appropriate protocol suitable for communication of data and/or code to/from the computer system 100. In various embodiments, the network 130 may represent a storage device or a combination of storage devices, either connected directly or indirectly to the computer system 100. In an embodiment, the network 130 may support Infiniband. In another embodiment, the network 130 may support wireless communications. In another embodiment, the network 130 may support hard-wired communications, such as a telephone line or cable. In another embodiment, the network 130 may support the Ethernet IEEE (Institute of Electrical and Electronics Engineers) 802.3x specification. In another embodiment, the network 130 may be the Internet and may support IP (Internet Protocol).

In another embodiment, the network 130 may be a local area network (LAN) or a wide area network (WAN). In another embodiment, the network 130 may be a hotspot service provider network. In another embodiment, the network 130 may be an intranet. In another embodiment, the network 130 may be a GPRS (General Packet Radio Service) network. In another embodiment, the network 130 may be a FRS (Family Radio Service) network. In another embodiment, the network 130 may be any appropriate cellular data network or cell-based radio network technology. In another embodiment, the network 130 may be an IEEE 802.11B wireless network. In still another embodiment, the network 130 may be any suitable network or combination of networks. Although one network 130 is shown, in other embodiments any number (including zero) of networks (of the same or different types) may be present.

The server 132 includes a grid executor 134 and may also include some or all of the hardware components already described for the computer system 100. In another embodiment, the functions of the server 132 may be implemented as an application in the computer system 100.

It should be understood that FIG. 1 is intended to depict the representative major components of the computer system 100, the network 130, and the server 132 at a high level, that individual components may have greater complexity than represented in FIG. 1, that components other than or in addition to those shown in FIG. 1 may be present, and that the number, type, and configuration of such components may vary. Several particular examples of such additional complexity or additional variations are disclosed herein; it being understood that these are by way of example only and are not necessarily the only such variations.

The various software components illustrated in FIG. 1 and implementing various embodiments of the invention may be implemented in a number of manners, including using various computer software applications, routines, components, programs, objects, modules, data structures, etc., referred to hereinafter as “computer programs,” or simply “programs.” The computer programs typically comprise one or more instructions that are resident at various times in various memory and storage devices in the computer system 100, and that, when read and executed by one or more processors 101 in the computer system 100, cause the computer system 100 to perform the steps necessary to execute steps or elements comprising the various aspects of an embodiment of the invention.

Moreover, while embodiments of the invention have and hereinafter will be described in the context of fully-functioning computer systems, the various embodiments of the invention are capable of being distributed as a program product in a variety of forms, and the invention applies equally regardless of the particular type of signal-bearing medium used to actually carry out the distribution. The programs defining the functions of this embodiment may be stored in, encoded on, and delivered to the computer system 100 via a variety of tangible signal-bearing media, which include, but are not limited to the following computer-readable media:

(1) information permanently stored on a non-rewriteable storage medium, e.g., a read-only memory or storage device attached to or within a computer system, such as a CD-ROM, DVD−R, or DVD+R;

(2) alterable information stored on a rewriteable storage medium, e.g., a hard disk drive (e.g., the DASD 125, 126, or 127), CD-RW, DVD−RW, DVD+RW, DVD-RAM, or diskette; or

(3) information conveyed by a communications or transmission medium, such as through a computer or a telephone network, e.g., the network 130.

Such tangible signal-bearing media, when carrying or encoded with computer-readable, processor-readable, or machine-readable instructions or statements that direct or control the functions of the present invention, represent embodiments of the present invention.

Embodiments of the present invention may also be delivered as part of a service engagement with a client corporation, nonprofit organization, government entity, internal organizational structure, or the like. Aspects of these embodiments may include configuring a computer system to perform, and deploying software systems and web services that implement, some or all of the methods described herein. Aspects of these embodiments may also include analyzing the client company, creating recommendations responsive to the analysis, generating software to implement portions of the recommendations, integrating the software into existing processes and infrastructure, metering use of the methods and systems described herein, allocating expenses to users, and billing users for their use of these methods and systems.

In addition, various programs described hereinafter may be identified based upon the application for which they are implemented in a specific embodiment of the invention. But, any particular program nomenclature that follows is used merely for convenience, and thus embodiments of the invention should not be limited to use solely in any specific application identified and/or implied by such nomenclature.

The exemplary environments illustrated in FIG. 1 are not intended to limit the present invention. Indeed, other alternative hardware and/or software environments may be used without departing from the scope of the invention.

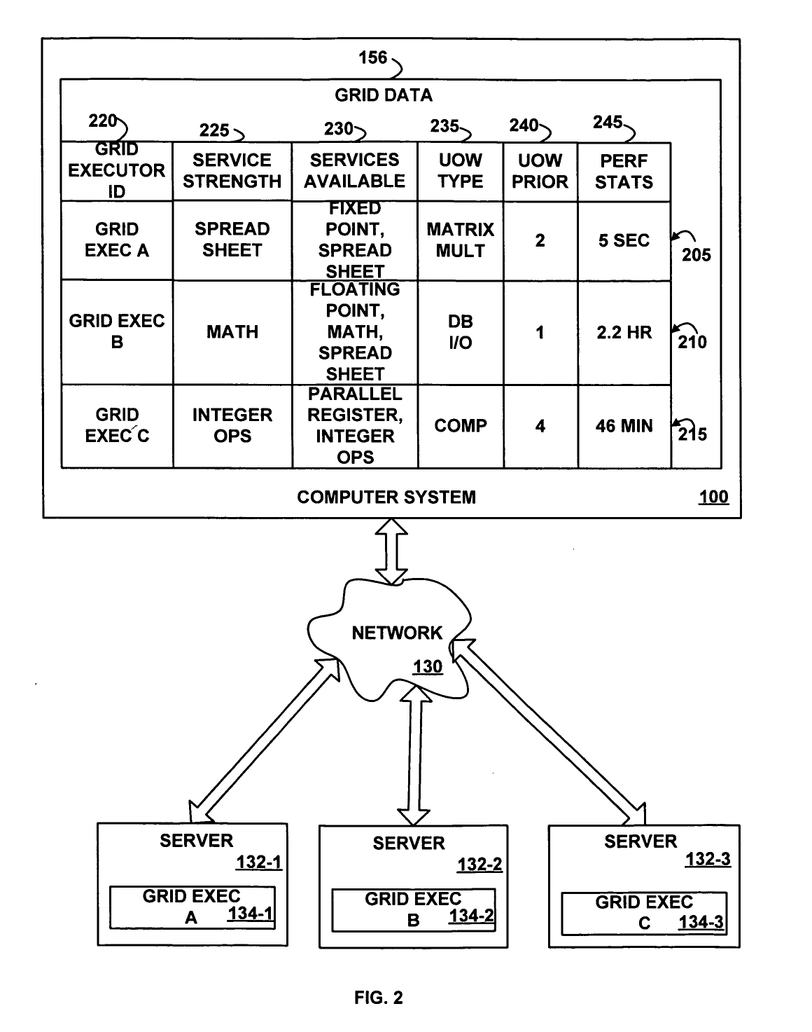

FIG. 2 depicts a block diagram of selected components of the example system, according to an embodiment of the invention. In the example illustrated system, the computer system 100 is connected to a server 132-1, a server 132-2, and a server 132-3 via the network 130. Each of the servers 132-1, 132-2, and 132-3 is an example of the server 132, as previously described above with reference to FIG. 1. The server 132-1 includes a grid executor A 134-1, the server 132-2 includes a grid executor B 134-2, and the server 132-3 includes a grid executor C 134-3.

The computer system 100 includes the grid data 156, which includes example records 205, 210, and 215, but in other embodiments any number of records with any appropriate data may be present. Each of the example records includes a grid executor identifier field 220, a service strength field 225, a services available field 230, a unit of work type field 235, a unit of work priority field 240, and a performance statistics field 245.

The grid executor identifier field 220 identifies one of the grid executors 134 such as the grid executor A 134-1, the grid executor B 134-2, or the grid executor C 134-3. The service strength 225 indicates a service or services for which the associated grid executor 220 performs faster than other services that the grid executor 220 provides. The services available 230 indicates services that are available at the grid executor 220, regardless of the speed at which the grid executor 220 performs them. The service strengths 225 are a subset of the services available 230 for a particular grid executor 220.

The unit of work type 235 indicates a type of unit of work that the grid manager 150 has sent to the grid executor 220. The unit of work priority 240 indicates the priority of the unit of work type 235, as reported by the grid application 154 or as specified by the grid manager 150. The performance statistics 245 indicates the previous performance of units of work having the unit of work type 235 when issued to the grid executor 220. In various embodiments, the performance statistics 245 may include the response time for processing the unit of work type 235 or the percentage of time that the grid executor 220 is available for processing the unit of work type 235.

FIG. 3 depicts a flowchart of processing for registering the grid executors 134, according to an embodiment of the invention. Control begins at block 300. Control then continues to block 305 where the grid manager 150 receives service strengths and available services from the grid executors 134. Control then continues to block 310 where the grid manager 150 creates a record (such as the record 205, 210, or 215) in the grid data 156 and stores the grid executor identifier 220, the reported service strengths 225 of the grid executors 134, and the reported available services 230 of the grid executors 134. Control then continues to block 399 where the logic of FIG. 3 returns.

FIG. 4 depicts a flowchart for processing units of work in a training mode, according to an embodiment of the invention. Control begins at block 400. Control then continues to block 405 where the grid manager 150 creates units of work based on the grid application 154. In various embodiments, the grid manager 150 may create the units of work based on and/or in response to the tasks, functions, requests, messages, interrupts, or actions of the grid application 154. The grid manager 150 further determines the type of the created unit of work and a priority of the created unit of work. The grid manager may determine the priority of the unit of work based on the priority of the grid application 154 on which the unit of work is based, based on a priority reported by the grid application 154 on which the unit of work is based, or based on any other technique.

Control then continues to block 410 where the grid manager 150 selects grid executors 134 based on the service strengths 225 of the grid executors 134, the services available 230 of the grid executors 134, the type of the created unit of work, and the priority of the created unit of work. In an embodiment, the grid manager 150 may select the grid executor 134 that has a service strength 225 that matches the unit of work type. In another embodiment, the grid manager 150 may use either the services available 230 or the service strengths 225 of the grid executors 134 to select the grid executors 134 depending on the priority of the unit of work. For example, if the priority of the unit work is high (above a threshold), the grid manager 150 may select the grid executors 134 whose service strengths 225 match the unit of work type, but if the priority of the unit of work is low (below the threshold) the grid manager 150 uses the services available 230 to select the grid executors 134. Thus, the grid manager 150 selects a subset of the grid executors 134 from which the grid manager 150 received the services strengths 225 and the services available 230.

The grid manager 150 stores the unit of work type of the created unit of work into the unit of work type field 235 of the records in the grid data 156 associated with the selected grid executors 134. The grid manager 150 further sets the unit of work priority associated with the created unit of work into the unit of work priority field 240 in the record associated with the selected grid executors 134.

Control then continues to block 415 where the grid manager 150 sends the created units of work to the selected grid executors 134 in parallel, meaning that the units of work are sent to multiple of the selected grid executors 134 without waiting for a response from any one particular grid executor 134. At least one of the grid executors 134 executes the units of work and returns a response to the grid application 154.

Control then continues to block 420 where the grid manager 150 retrieves performance statistics data associated with the parallel execution of the units of work and stores the performance statistics data in the performance statistics field 245 of the records associated with the grid executors 220 that executed the units of work.

Control then continues to block 425 where the grid manager 150 creates training data based on the service strengths 225, the unit of work type 235, and the performance statistics 245. In an embodiment, the grid manager 150 selects those grid executors 220 (those records in the grid data 156), for every unit of work type 235, that have the best performance statistics 245, e.g., the lowest response time or the highest availability. The grid manager 150 then creates training data that includes pairs of unit of work types 235 and service strengths 225. Control then continues to block 430 where the grid manager 150 trains the neural network 152 with the unit of work types 235 as input to the neural network 152 and the respective paired service strengths 225 as output from the neural network 152. That is, the grid manager 150 repeatedly inputs the work types 235 to the neural network 152 until the neural network 152 produces the paired respective service strengths 225 as output at least a threshold percentage of the time. Control then continues to block 499 where the logic of FIG. 4 returns.

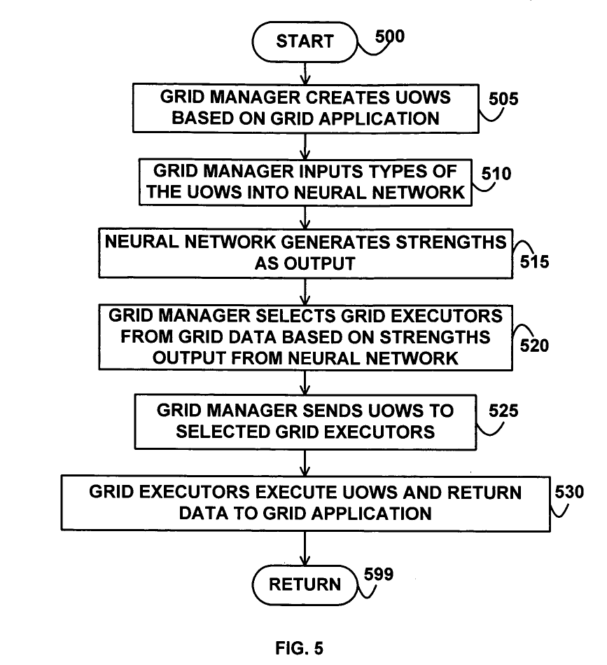

FIG. 5 depicts a flowchart for processing units of work in a performance mode after the training mode is complete, according to an embodiment of the invention. Control begins at block 500. Control then continues to block 505 where the grid manager 150 creates units of work based on the grid application 154, as previously described above with reference to block 405 of FIG. 4.

Control then continues to block 510 where the grid manager 150 inputs the types 235 of the units of work into the neural network 152. Control then continues to block 515 where the neural network 152 generates the service strengths 225 as output. Control then continues to block 520 where the grid manager 150 selects the grid executors 134 from the grid data 156 based on the service strengths 225 that were output from the neural network 152. In an embodiment, the grid manager 150 selects those grid executors 134 with service strengths 225 that match the output service strengths from the neural network 152.

Control then continues to block 525 where the grid manager 150 sends the units of work in parallel to the selected grid executors 134 identified by the grid executor identifier 220. Control then continues to block 530 where at least one of the selected grid executors 134 executes the units of work and returns a response to the grid application 154.

In the previous detailed description of exemplary embodiments of the invention, reference was made to the accompanying drawings (where like numbers represent like elements), which form a part hereof, and in which is shown by way of illustration specific exemplary embodiments in which the invention may be practiced. These embodiments were described in sufficient detail to enable those skilled in the art to practice the invention, but other embodiments may be utilized and logical, mechanical, electrical, and other changes may be made without departing from the scope of the present invention. Different instances of the word “embodiment” as used within this specification do not necessarily refer to the same embodiment, but they may. The previous detailed description is, therefore, not to be taken in a limiting sense, and the scope of the present invention is defined only by the appended claims.

In the previous description, numerous specific details were set forth to provide a thorough understanding of embodiments of the invention. But, the invention may be practiced without these specific details. In other instances, well-known circuits, structures, and techniques have not been shown in detail in order not to obscure the invention.

What is claimed is:

1. A method comprising:
sending a first plurality of units of work to a first plurality of grid executors in parallel;
creating training data based on performance of the first plurality of grid executors;
training a neural network via the training data; and
selecting a second plurality of grid executors via the neural network.

2. The method of claim 1, further comprising:
sending a second unit of work to the second plurality of grid executors in parallel.

3. The method of claim 1, further comprising:
receiving a service strength from each of the first plurality of grid executors.

4. The method of claim 3, wherein the creating the training data further comprises:
creating a plurality of pairs of input data and output data based on the performance, wherein the input data comprises a plurality of types of the first plurality of units of work and the output data comprises the service strengths of the first plurality of grid executors.

5. The method of claim 4, wherein the creating the training data further comprises:
selecting the plurality of types based on response time for the plurality of types at the first plurality of grid executors.

6. The method of claim 2, wherein the selecting further comprises:
inputting a type of the second unit of work to the neural network; and
receiving a second service strength from the neural network.

7. The method of claim 6, wherein the selecting further comprises:
selecting the second plurality of grid executors based on the second service strength from the neural network.

8. A signal-bearing medium encoded with instructions, wherein the instructions when executed comprise:
receiving a service strength from each of a first plurality of grid executors;
selecting a subset of the first plurality of grid executors based on the service strength;
sending a first plurality of units of work to the subset of the first plurality of grid executors in parallel;
creating training data based on performance of the subset of the first plurality of grid executors;
training a neural network via the training data; and
selecting a second plurality of grid executors via the neural network.

9. The signal-bearing medium of claim 8, further comprising:
sending a second unit of work to the second plurality of grid executors in parallel.

10. The signal-bearing medium of claim 8, wherein the creating the training data further comprises:
creating a plurality of pairs of input data and output data based on the performance, wherein the input data comprises a plurality of types of the first plurality of units of work and the output data comprises the service strengths of the subset of the first plurality of grid executors.

11. The signal-bearing medium of claim 10, wherein the creating the training data further comprises:
selecting the plurality of types based on response time for the plurality of types at the subset of the first plurality of grid executors.

12. The signal-bearing medium of claim 9, wherein the selecting further comprises:
inputting a type of the second unit of work to the neural network; and
receiving a second service strength from the neural network.

13. The signal-bearing medium of claim 12, wherein the selecting further comprises:
selecting the second plurality of grid executors based on the second service strength from the neural network.

14. The signal-bearing medium of claim 8, wherein the receiving further comprises:
receiving services available from each of the first plurality of grid executors.

15. A method for configuring a computer, comprising:
configuring the computer to receive a service strength and services available from each of a first plurality of grid executors;
configuring the computer to select a subset of the first plurality of grid executors based on a priority and one of the service strength and services available;
configuring the computer to send a first plurality of units of work to the subset of the first plurality of grid executors in parallel;
configuring the computer to create training data based on performance of the subset of the first plurality of grid executors;
configuring the computer to train a neural network via the training data; and
configuring the computer to select a second plurality of grid executors via the neural network.

16. The method of claim 15, further comprising:
configuring the computer to send a second unit of work to the second plurality of grid executors in parallel.

17. The method of claim 15, wherein the configuring the computer to create the training data further comprises:
configuring the computer to create a plurality of pairs of input data and output data based on the performance, wherein the input data comprises a plurality of types of the first plurality of units of work and the output data comprises the service strengths of the subset of the first plurality of grid executors.

18. The method of claim 17, wherein the configuring the computer to create the training data further comprises:
configuring the computer to select the plurality of types based on response time for the plurality of types at the subset of the first plurality of grid executors.

19. The method of claim 16, wherein the configuring the computer to select further comprises:
configuring the computer to input a type of the second unit of work to the neural network; and
configuring the computer to receive a second service strength from the neural network.

20. The method of claim 19, wherein the configuring the computer to select further comprises:
configuring the computer to select the second plurality of grid executors based on the second service strength from the neural network.
